(19) United States
(12) Patent Application Publication
(10) Pub. No.: US 2006/0221239 A1
(43) Pub. Date: Oct. 5, 2006

(54) Method and device for processing video data for display on a display device

(76) Inventors: Cedric Thebault, Villingen-Schwenningen (DE); Carlos Correa, Villingen-Schwenningen (DE); Sebastien Weitbruch, Niedereschach (DE)

Correspondence Address: THOMSON LICENSING INC., PATENT OPERATIONS, PO BOX 5312, PRINCETON, NJ, 08543-5312, US

(21) Appl. No.: 10/541,856

(22) PCT Filed: Dec. 18, 2003
(86) PCT No.: PCT/EP03/51052

§ 371 Date: Jun. 1, 2006

(30) Foreign Application Priority Data
Jan. 10, 2003 (EP) 03290063.1

(51) Int. Cl. H04N 5/14; H04N 9/64

(52) U.S. Cl. 348/571; 348/575; 348/576

(57) ABSTRACT

The visible pattern of classical matrix dithering in case of applications with moving pictures and static pictures shall be suppressed more effectively. Therefore, it is proposed to change a dithering pattern in the dithering block non-periodically. This can be effected by a random generator which may be activated by a motion detector. The motion detector enables to individually alternate the dithering function depending on moving or static pictures.

The present invention relates to a method for processing video data for display on a display device having a plurality of luminous elements by applying a dithering function to at least a part of the video data to refine the grey scale portrayal of video pictures of the video data. Furthermore, the present invention relates to a corresponding device for processing video data including dithering means.

### BACKGROUND

A PDP (Plasma Display Panel) utilizes a matrix array of discharge cells, which can only be “ON”, or “OFF”. Unlike a CRT or LCD in which grey levels are expressed by analogue control of the light emission, a PDP controls the grey level by modulating the number of light pulses per frame (sustain pulses). This time-modulation will be integrated by the eye over a period corresponding to the eye time response. Since the video amplitude is portrayed by the number of light pulses, occurring at a given frequency, more amplitude means more light pulses and thus more “ON” time. For this reason, this kind of modulation is also known as PWM, pulse width modulation.

This PWM is responsible for one of the PDP image quality problems: the poor grey scale portrayal quality, especially in the darker regions of the picture. This is due to the fact, that displayed luminance is linear to the number of pulses, but the eye response and sensitivity to noise is not linear. In darker areas the eye is more sensitive than in brighter areas. This means that even though modern PDPs can display ca. 255 discrete video levels, quantization error will be quite noticeable in the darker areas.

As mentioned before, a PDP uses PWM (pulse width modulation) to generate the different shades of grey. Contrarily to CRTs where luminance is approximately quadratic to applied cathode voltage, luminance is linear to the number of discharge impulses. Therefore an approximately digital quadratic gamma function has to be applied to video before the PWM.

Due to this gamma function, for smaller video levels, many input levels are mapped to the same output level. In other words, for darker areas, the output number of quantization bits is smaller than the input number, in particular for values smaller than 16 (when working with 8 bit for video input) that are all mapped to 0. This also counts for four bit resolution which is actually unacceptable for video.

One known solution to improve the quality of the displayed pictures is to artificially increase the number of displayed video levels by using dithering. Dithering is a known technique for avoiding to loose amplitude resolution bits due to truncation. However, this technique only works if the required resolution is available before the truncation step. Usually this is the case in most applications, since the video data after a gamma operation used for pre-correction of the video signal has 16-bit resolution. Dithering can bring back as many bits as those lost by truncation in principle. However, the dithering noise frequency decreases, and therefore becomes more noticeable, with the number of dithered bits.

The concept of dithering shall be explained by the following example. A quantization step of 1 shall be reduced by dithering. The dithering technique uses the temporal integration property of the human eye. The quantization step may be reduced to 0.5 by using 1-bit dithering. Accordingly, half of the time within the time response of the human eye there is displayed the value 1 and half of the time there is displayed the value 0. As a result the eye sees the value 0.5. Optionally, the quantization steps may be reduced to 0.25. Such dithering requires two bits. For obtaining the value 0.25 a quarter of the time the value 1 is shown and three quarters of the time the value 0. For obtaining the value 0.5 two quarters of the time the value 1 and two quarters of the time the value 0 is shown. Similarly, the value 0.75 may be generated. In the same manner quantization steps of 0.125 may be obtained by using 3-bit dithering. This means that 1 bit of dithering corresponds to multiply the number of available output levels by 2, 2 bits of dithering multiply by 4, and 3 bits of dithering multiply by 8 the number of output levels. A minimum of 3 bits of dithering may be required to give to the grey scale portrayal a ‘CRT’ look.

Proposed dithering methods in the literature (like error diffusion) were mainly developed to improve quality of still images (fax application and newspaper photo portrayal). Results obtained are therefore not optimal for PDPs.

The dithering most adapted to PDP until now is the Cell-Based Dithering, described in the European patent application EP-A-1 136 974 and Multi-Mask dithering described in the European patent application with the filing number 01 250 199.5, which improves grey scale portrayal but adds high frequency low amplitude dithering noise. It is expressively referred to both documents.

Cell-based dithering adds a temporal dithering pattern that is defined for every panel cell and not for every panel pixel as shown in FIG. 1. A panel pixel is composed of three cells: red, green and blue cell. This has the advantage of rendering the dithering noise finer and thus less noticeable to the human viewer.

Because the dithering pattern is defined cell-wise, it is not possible to use techniques like error-diffusion, in order to avoid colouring of the picture when one cell would diffuse in the contiguous cell of a different colour. Instead of using error diffusion, a static 3-dimensional dithering pattern is proposed.

This static 3-dimentional dithering is based on a spatial (2 dimensions x and y) and temporal (third dimension t) integration of the eye. For the following explanations, the matrix dithering can be represented as a function with three variables: φ(x,y,t). The three parameters x, y and t will represent a kind of phase for the dithering. (φ_{y,t}: x->φ(x,y,t), φ_{x,t}: y->φ (x,y,t) and φ_{x,y}: t->φ (x,y,t) are periodic). Now, depending on the number of bits to be rebuilt, the period of these three phases can change. For each frame, each function φₜ: (x,y)->φ (x,y,t) represents a (2-dimensional) pattern of dithering.

FIG. 2 illustrates the 3-dimensional matrix concept. The values displayed on the picture slightly change for each plasma cell in the vertical and horizontal directions. In addition, the value also changes for each frame.

In the example of FIG. 2, for the frame displayed at time tₒ the following dithering values are given:
φ(xₒ,yₒ,tₒ)=A
φ(xₒ+1,yₒ,tₒ)=B
φ(xₒ+1,yₒ+1,tₒ)=A
φ(xₒ,yₒ+1,tₒ)=B

One frame later, at time tₒ+1 the dithering values are:
φ(xₒ,yₒ,tₒ+1)=B
φ(xₒ+1,yₒ,tₒ+1)=A
φ(xₒ+1,yₒ+1,tₒ+1)=B
φ(xₒ,yₒ+1,tₒ+1)=A

The spatial resolution of the eye is good enough to be able to see a fixed static pattern A, B, A, B but if a third dimension, namely the time, is added in the form of an alternating function, then the eye will be only able to see the average value of each cell.

The case of a cell located at the position (xₒ,yₒ) shall be considered. The value of this cell will change from frame to frame as following φ (xₒ,yₒ,tₒ)=A, φ (xₒ,yₒ,tₒ+1)=B, φ (xₒ,yₒ,tₒ+2)=A and so on.

The eye time response of several milliseconds (temporal integration) can be then represented by the following formula:

$$Eye ( {x}_{o} , {y}_{o} ) = \frac{1}{T} {\sum }_{t = {t}_{o}}^{t = {t}_{o} + T} φ ( {x}_{o} , {y}_{o} , t )$$

which, in the present example, leads to

$$Eye ( {x}_{o} , {y}_{o} ) = \frac{A + B}{2}$$

It should be noted that the proposed pattern, when integrated over time, always gives the same value for all panel cells. If this would not be the case, under some circumstances, some cells might acquire an amplitude offset to other cells, which would correspond to an undesirable fixed spurious static pattern.

While displaying moving objects on the plasma screen, the human eye will follow the objects and no more integrates the same cell of the plasma (PDP) over the time. In that case, the third dimension will no more work perfectly and a dithering pattern can be seen.

In order to better understand this problem, the following example of a movement \vec{V}=(1;0) shall be looked at, which represents a motion in x-direction of one pixel per frame as shown in FIG. 3. In that case, the eye will look at (xₒ,yₒ) at time tₒ and then it will follow the movement to pixel (xₒ+1,yₒ) at time tₒ+1 and so on. In that case, the cell seen by the eye will be defined as following:

$$Eye = \frac{1}{T} ( \begin{matrix}φ ( {x}_{o} , {y}_{o} , {t}_{o} ) + φ ( {x}_{o} + 1 , {y}_{o} , {t}_{o} + 1 ) + … + \\ φ ( {x}_{o} + T , {y}_{o} , {t}_{o} + T )\end{matrix} )$$

which corresponds to

$$Eye = \frac{1}{T} ( A + A + … + A ) = A .$$

In that case, the third dimension aspect of the dithering will not work correctly and only the spatial dithering will be available. Such an effect will make the dithering more or less visible depending on the movement. The dithering pattern is no longer hidden by the spatial and temporal eye integration. Especially, for some motions, an awkward pattern can appear. The same kind of problem can also appear for the same reason when the picture to be displayed already includes a dithering. This is the case for some PC applications. Then the two ditherings can interfere with each other and also produce a strong fixed pattern.

In view of that, it is the object of the present invention to provide a method and a device with an improved dithering function.

According to the present invention this object is solved by a method for processing video data for display on a display device having a plurality of luminous elements including the steps of applying a dithering function to at least one part of said video data to refine the grey scale portrayal of video pictures of said video data, providing a modulation function being non-peridodical and changing the phase or amplitude of said dithering function in accordance with said modulation function when applying said dithering function to said at least one part of said video data.

Furthermore, according to the present invention there is provided a device for processing video data for display on a display device having a plurality of luminous elements including dithering means for applying a dithering function to at least one part of said video data to refine the grey scale portrayal of video pictures of said video data, wherein said dithering means includes modulation means for modulating the phase or amplitude of the dithering function with a modulation function being non-periodical.

The inventive modulation function enables a dithering which is less perceptible for viewers when static or moving pictures are presented. The reason for this is, that the human eye will not integrate periodical patterns of the dithering function which would be visible.

Advantageously, the modulation function includes a random function. Such random function causes a dithering pattern to appear non-periodically. This means, that at a given time a dithering pattern appears by chance so that the viewer will not percept an awkward pattern.

The dithering function may include two spatial dimensions beside the temporal dimension given by the modulation function. Such structure enables an advanced matrix dithering.

Advantageously, the dithering function is a 1-, 2-, 3- and/or 4-bit dithering function. The number of bits used depends on the processing capability. In general, 3-bit dithering is enough, so that most of the quantization noise is not visible.

As already mentioned, a pre-correction by the quadratic gamma function should be performed before the dithering process. Thus, also the quantization errors produced by the gamma function correction are reduced with the help of dithering.

The temporal component of the dithering function may be introduced by controlling the dithering in the rhythm of picture frames. Thus, no additional synchronisation has to be provided.

The dithering according to the present invention may be based on a Cell-based and/or Multi-Mask dithering, which consists in adding a dithering signal that is defined for every plasma cell and not for every pixel. In addition, such a dithering may further be optimized for each video level. This makes the dithering noise finer and less noticeable to the human viewer.

An adaptation of the dithering pattern to the movement of the picture in order to suppress the dithering structure appearing for specific movement may be obtained by using a motion estimator to change the phase or other parameters of the dithering function for each cell. In that case, even if the eye is following the movement, the quality of the dithering will stay constant and a pattern of dithering in case of motion will be suppressed. Furthermore, this invention can be combined with any kind of matrix dithering.

### DRAWINGS

Exemplary embodiments of the invention are illustrated in the drawings and are explained in more detail in the following description. In the drawings:

FIG. 1 shows the principle of the pixel-based dithering and cell based dithering;

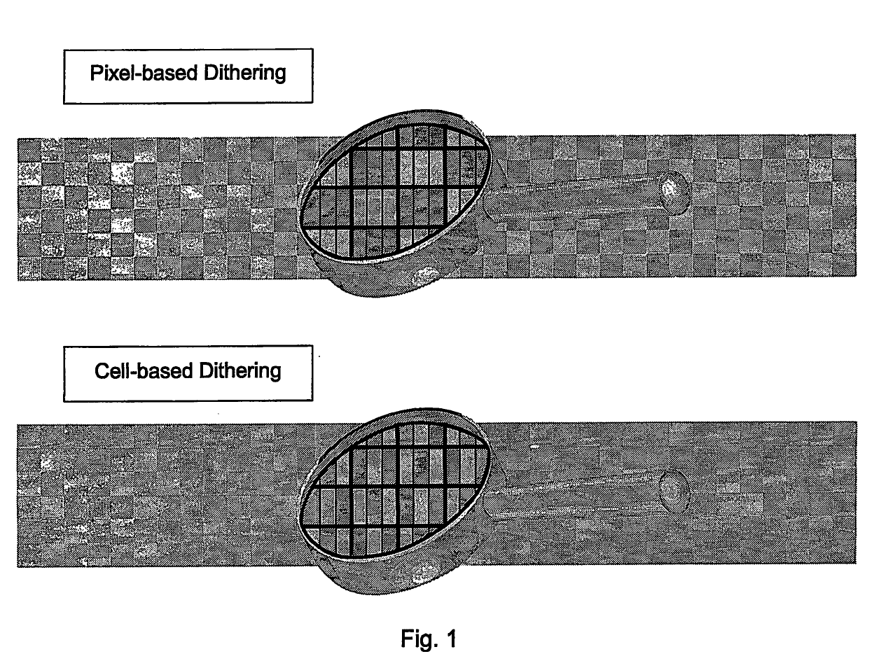

FIG. 2 illustrates the concept of 3-dimensional matrix dithering;

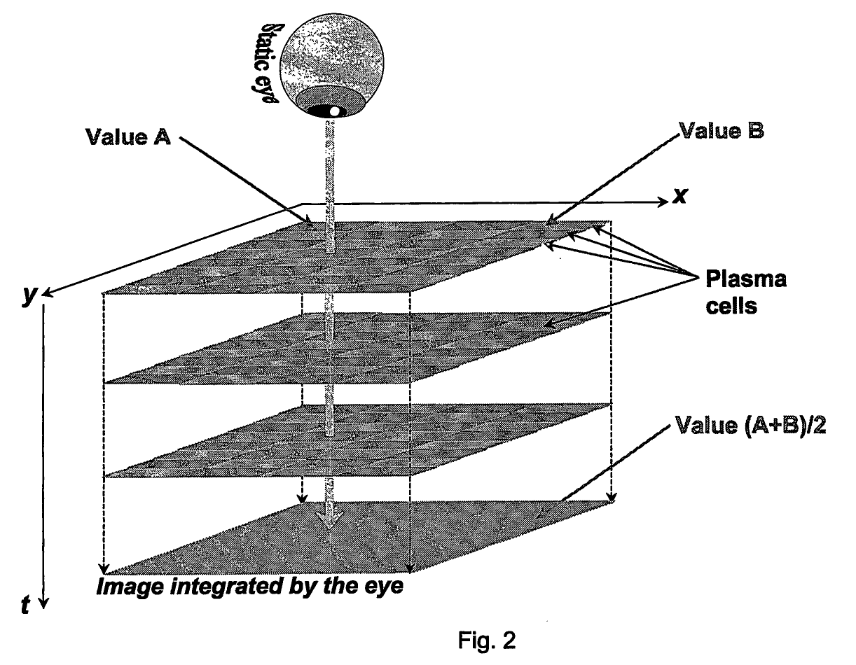

FIG. 3 shows the principle of eye integration for a moving picture, when 3-dimensional matrix dithering is applied; and

FIG. 4 shows a block diagram of a hardware implementation for the algorithm according to the present invention.

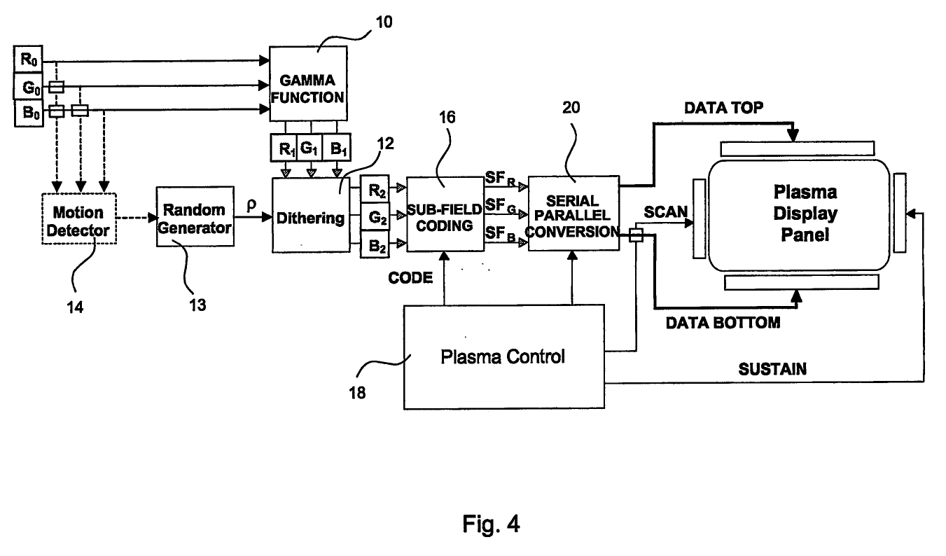

### EXEMPLARY EMBODIMENTS

The following embodiment aims at eliminating the dithering pattern appearing with the cell-based dithering during movement in order to only have advantages compared to Error-Diffusion. This will be achieved by using a random sequence of dithering patterns instead of a predetermined one like in the prior art. Owing to this principle the overall picture quality is the same for static and moving pictures.

Matrix Dithering with Random Pattern-Sequence

The problem with the fixed matrix dithering is due to its structure, which is totally definite. In order to avoid such problems, the dithering must be less foreseeable and its structure more complicated. To obtain this result, the pattern of dithering to be applied to the picture may be randomly alternated in order to achieve a matrix dithering random pattern-sequence. This can be done by using a random function t→ρ(t) in place of t. The new dithering function will be defined by: φ(x,y,ρ(t)). consequently, a dithering value φ(x,y,ρ(t)) is assigned to each 3-dimensional vector (x,y,t).

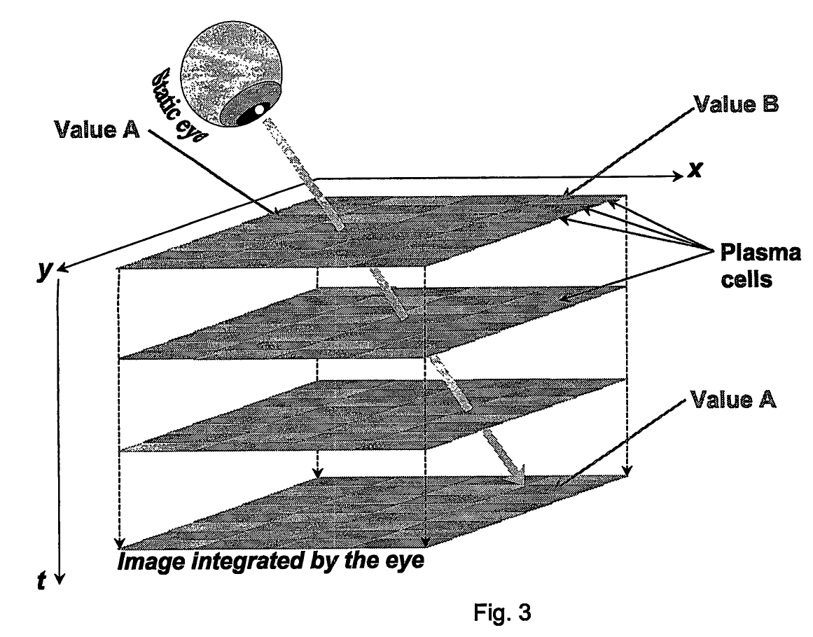

This can be illustrated by means of an example: φ(x,y,t)=(x+y+t) modulo 2. Furthermore, according to FIG. 3 it is assumed that A=0 and B=1 to generate a level of 0.5.

If there is no motion, the eye will see for a given pixel, a temporal sequence of 0 and 1. And if there is a motion of 1 pixel/frame for example, the eye will continuously see depending on the pixel either 0 or 1 as already explained previously.

According to a preferred embodiment a random function ρ which takes the following values for t=tₒ . . . t₂₃ . . . : ρ(t₀),ρ(t₁) . . . ,ρ(t₂₃) . . . =1,1,0,1,0,0,1,0,1,1,0,0,0,1,0,0,1,1,1,0,0,0,1,1 . . . is used. Since there are only two different dithering patterns, the random generator generates the values 0 and 1.

If there is no motion, the eye will see the sequence: 1,1,0,1,0,0,1,0,1,1,0,0,0,1,0,0,1,1,1,0,0,0,1,1 (or the inverse one depending on the pixel: 0,0,1,0,1,1,0,1,0,0,1,1,1,0,1,1,0,0,0,1,1,1,0,0). However, if there is a motion of 1 pixel/frame for example, the eye will see the resulting sequence: 1,0,0,0,0,1,1,1,1,0,0,1,0,0,0,1,1,0,1,1,0,1,1,0 (or the inverse one depending on the pixel: 0,1,1,1,1,0,0,0,0,1,1,0,1,1,1,0,0,1,0,0,1,0,0,1). The resulting sequence is obtained by taking the first value of the random function, the second value of the inverse random function, the third value of the random function and so on.

The sequence will look similarity for any motion. It will always have the same characteristics as the original sequence of dithering.

The temporal frequency of dithering for a motion of 1 pixel/frame will not be as high as for static pictures, so that lower frequencies will appear. This means that the dithering will be more perceptible. But the dithering will still work correctly, and there will be no difference between the quality of dithering on a static and on a moving picture. In comparison with standard cell-based dithering, static pictures look noisier, but it is quite better for most moving pictures.

Optionally, a motion detector or estimator can be employed to decide whether the random dithering has to be used instead of the standard dithering. The random dithering should be used for moving pictures, the standard one for static pictures.

Preferably 3-bit dithering is implemented so that up to 8 frames are used for dithering. If the number of frames used for dithering is increased, the frequency of the dithering might be too low, and so flicker will appear. Mainly 3-bit dithering is rendered with a 8-frames cycle and a 2D spatial component. In this case the random generator generates the values 0 to 7, since eight dithering patterns are used.

FIG. 3 illustrates a possible implementation for the algorithm. RGB input pictures indicated by the signals R₀, G₀ and B₀ are forwarded to a gamma function block 10. It can consist of a look up table (LUT) or it can be formed by a mathematical function. The outputs R₁, G₁ and B₁ of the gamma function block 10 are forwarded to a dithering block 12 which takes into account the pixel position and a random value p given by a random generator 13 for the computation of the dithering value according to the above equation. The random generator 13 optionally receives an input from a motion detector 14. The input signal serves for activating the random generator 13. If it is not activated, the random generator just increments the value of ρ in order to alternate the dithering pattern in the same order as for standard cell-based dithering. The motion detector 14 can take the whole picture or predetermined parts of the picture transmitted in the signals R₀, G₀, B₀ as basis for forming the iput signal for the random generator 13 in order to make the dithering more adaptable to the different types of pictures.

The video signals R₁, G₁, B₁ subjected to the dithering in the dithering block 12 are output as signals R2, G2, B2 and are forwarded to a sub-field coding unit 16 which performs sub-field coding under the control of the control unit 18. The plasma control unit 18 provides the code for the sub-field coding unit 16.

As to the sub-field coding it is expressively referred to the already mentioned European patent application EP-A-1 136 974.

The sub-field signals for each colour output from the sub-field coding unit 16 are indicated by reference signs SF_{R}, SF_{G}, SF_{B}. For plasma display panel addressing, these sub-field code words for one line are all collected in order to create a single very long code word which can be used for the linewise PDP addressing. This is carried out in a serial to parallel conversion unit 20 which is itself controlled by the plasma control unit 18.

Furthermore, the control unit 18 generates all scan and sustain pulses for PDP control. It receives horizontal and vertical synchronizing signals for reference timing.

In the present embodiment the use of a motion estimator is recommended, however, such a motion estimator or detector can be used for other skills like false contour compensation, sharpness improvement and phosphor lag reduction. In this case since the same motion vectors can be reused the extra costs are limited.

Motion compensated dithering is applicable to all colour cell based displays (for instance colour LCDs) where the number of resolution bits is limited.

The present invention brings the advantage of suppressing the visible pattern of classical matrix dithering in case of applications with moving pictures and static pictures.

1. Method for processing video data for display on a display device having a plurality of luminous elements by
applying a gamma function to at least one part of said video data and then applying a dithering function to said video data to refine the grey scale portrayal of video pictures of said video data,
wherein
a modulation function being non-periodical is provided and
the phase or amplitude of said dithering function is changed in accordance with said modulation function when applying said dithering function to said at least one part of said video data.

2. Method according to claim 1, wherein the modulation function includes a random function.

3. Method according to claim 1, wherein said dithering function includes two spatial dimensions beside a temporal dimension given by a modulation function.

4. Method according to claim 1, wherein said dithering function is a 1-, 2-, 3- and/or 4-bit dithering function.

5. Device for processing video data for display on a display device having a plurality of luminous elements including
gamma means for applying a gamma function to at least one part of said video data and
dithering means for applying a dithering function to said video data to refine the grey scale portrayal of video pictures of said video data,
wherein
said dithering means includes modulation means for modulating the phase or amplitude of the dithering function with a modulation function being non-periodical.

6. Device according to claim 5, wherein said modulation function is provided by a random generator connected to said dithering means.

7. Device according to claim 5, wherein the dithering function includes two spatial dimensions beside the temporary dimension obtained by the modulation function.

8. Device according to claim 5, wherein the dithering function is a 1-, 2-, 3- and/or 4-bit dithering function.
